(19) United States
(12) Patent Application Publication
(10) Pub. No.: US 2021/0074172 A1
(43) Pub. Date: Mar. 11, 2021

(54) MIDLINE EDUCATIONAL SYSTEM AND METHOD

(71) Applicant: MIDLINE, LLC, Pearl, MS (US)

(72) Inventor: Victoria J. Williams, Pearl, MS (US)

(73) Assignee: MIDLINE, LLC, Pearl, MS (US)

(21) Appl. No.: 16/563,649

(22) Filed: Sep. 6, 2019

(51) Int. Cl. G09B 7/00; G06Q 50/20

(52) U.S. Cl. CPC G09B 7/00; G09B 19/025; G06Q 50/205

(57) ABSTRACT

A midline educational system includes a display device with a series of digital displays for allowing students to practice of a plurality of academic skills using midline movement. A control provides display instructions to the display device and records the student's performance in simultaneously verbally reciting facts associated with the academic skills. The performance data is transmitted to a server, which stores the performance data in a database. Customized instructions are provided for each student using the display device. The server sets the customized instructions based on the student's identifying information, performance data in using the display device to practice academic skills, or test data related to academic skills. Administrators monitor the progress of a plurality of students through an administrative interface in communication with the server. The administrators input relevant test data, view performance data, view and update customized instructions, and generate reports for one or more students.

### BRIEF DESCRIPTION OF THE DRAWINGS

FIG. 1 is a schematic view of a midline educational system.

FIG. 2 is a schematic view of one embodiment of a process for a student to practice an academic skill using a display device of the midline educational system.

FIG. 3 is a schematic view of the communication pathways of the midline educational system.

FIG. 4 is a schematic view of a database of the midline educational system.

FIG. 5 is a flow chart of one embodiment of a process by which a server of the midline educational system creates customized instructions for a student's use of the display device.

FIG. 6 is one embodiment of an academic skill standard chart for use in the process illustrated in FIG. 5.

FIG. 7 is a second embodiment of an academic skill standard chart for use in the process illustrated in FIG. 5.

FIG. 8 is a flow chart of one embodiment of a process by which an administrator interacts with the server of the midline educational system.

FIG. 9 is a flow chart of one embodiment of a process by which a student interacts with a control and a server of the midline educational system for use of the display device to practice an academic skill.

### DETAILED DESCRIPTION OF THE PREFERRED EMBODIMENTS

A midline educational system is used to facilitate students' practice of one or more academic skills using midline movement to enhance the students' retention of the academic skills. “Midline movement” includes any movement that crosses the midline of the student's body, such as taking steps that cross the midline of the student's body at each digital display on a display device. In one embodiment, the midline movement is stepping with the student's right foot across to the left side of a display of a letter, number, word, or symbol associated with the academic skill. The student's performance in simultaneously verbally reciting the facts associated with the academic skill(s) is recorded by a control, and the performance data is transmitted to a server where it is stored in a performance dataset of a database.

The midline educational system also provides customized instructions for each student using the display device to practice academic skills. The server sets the customized instructions based on the student's identifying information, the student's performance data in using the display device to practice academic skills, or the student's test data that an administrator provides related to academic skills that may be practiced using the display device. The midline educational system also allows administrators to monitor the progress of a plurality of students using the display device to practice academic skills. The administrators may input relevant test data for students, view the performance data for each student, view the customized instructions associated with each student, update the customized instructions associated with each student, and to generate reports for one or more students. The reports may provide any of the data stored in the database for one or more students associated with the administrator. In this way, the midline educational system allows students to practice a variety of academic skills best suited for each student using midline movement, while allowing administrators to monitor the progress of a plurality of students on the academic skills.

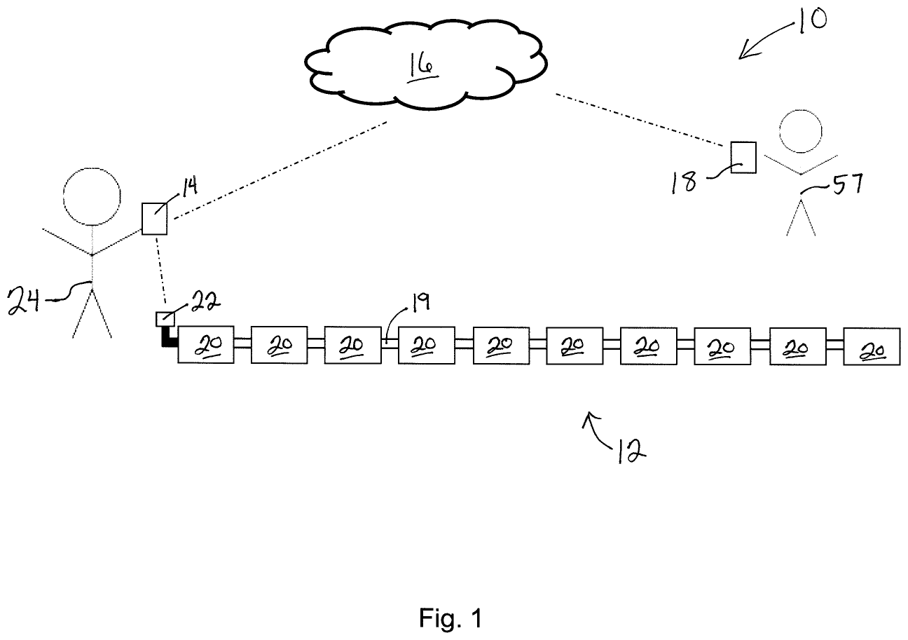

With reference to FIG. 1, midline educational system 10 includes display device 12, control 14 in electronic communication with display device 12, and server 16 in electronic communication with control 14. Control 14 may be a portable electronic device such as a smartphone, tablet, laptop computer, or watch. In one embodiment, control 14 may be affixed to display device 12 such that a wired connection may be used to facilitate electronic communication between control 14 and display device 12. Server 16 may also be in electronic communication with administrator device 18, which may be any type of computer or mobile device, such as a desktop computer, a laptop computer, a tablet, a smartphone, or a watch.

Display device 12 may include base 19 and a series of digital displays 20. In one embodiment, display device 12 includes 10-30 digital displays 20. Digital displays 20 are spaced apart from one another along the length of base 19. Display device 12 may also include receiver 22, which is configured to electronically communicate with control 14. Digital displays 20 may be configured to display a series of numbers, letters, words, images, or any combination thereof to allow student 24 to practice one or more academic skills, including but not limited to math skills for multiplication, division, addition, or subtraction; alphabetic skills; reading skills; English skills; or grammar skills. Display device 12 may have any shape or configuration, such as a circular, rectangular, or any other pattern formed by digital displays 20. Display device 12 may be portable to facilitate its movement from one location to another. In some embodiments, display device 12 may include a securing mechanism configured to secure base 19 or any other portion of display device 12 to the floor to prevent unintentional movement of display device 12 during use.

Student 24 may log into a software program on control 14 and select an academic skill to practice. Alternatively, server 16 may provide customized instructions for student 24, which instruct control 14 to direct student 24 to practice a predetermined academic skill. Control 14 then sends display instructions associated with the selected (or predetermined) academic skill to receiver 22 of display device 12. In response to the display instructions, digital displays 20 display a series of numbers, letters, words, images, or any combination thereof associated with the selected (or predetermined) academic skill. For example, if the selected or predetermined academic skill is “multiplication fact family 5,” then control 14 may transmit to receiver 22 instructions for digital displays 20 to display numbers 0, 5, 10, 15, 20, 25, 30, 35, 40, 45, 50, 55, and 60 (i.e., first digital display 20 displays 0, second digital display 20 displays 5, third digital display 20 displays 10, etc.). Control 14 may also provide physical instructions associated with the selected or predetermined academic skill to student 24. For example, control 14 may provide physical instructions in writing or with an audio recording.

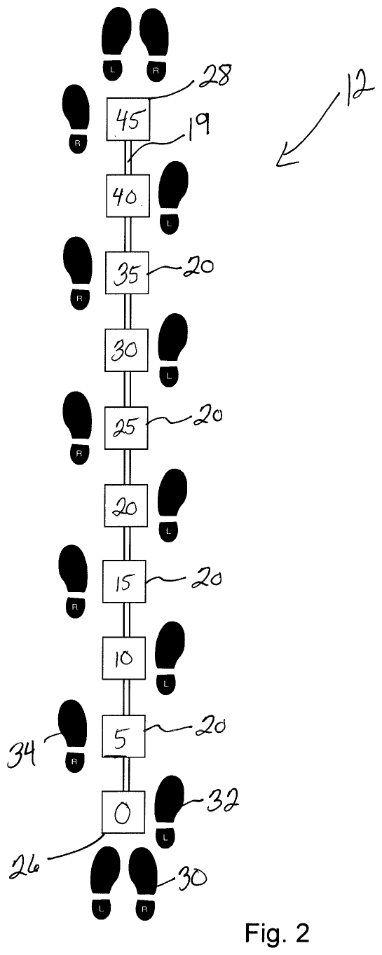

With reference to FIG. 2, the physical instructions provided by control 14 to student 24 provides a pattern of steps as student 24 walks from first end 26 of display device 12 to second end 28 of display. For example, the physical instructions may instruct student 24 to begin with both feet together at 30 at first end 26, then step across the first digital display 20 with the left foot at 32 while reciting the associated fact of the selected or predetermined academic skill (i.e., “5 times 0 equals 0”), then step across the second digital display 20 with the right foot at 34 while reciting the associated fact of the selected or predetermined academic skill (i.e., “5 times 1 equals 5”). Student 24 may follow these physical instructions (while reciting the appropriate fact of the academic skill at each step) by taking the step shown at 32 with the left foot, the step shown at 34 with the right foot, and continuing this sequence of alternately crossing over the midline of the student's body at each digital display 20 as illustrated.

Control 14 may be configured to record the verbal performance of student 24 as student 24 recites the facts of the academic skill. Control 14 may include voice recognition software to convert the audio recording to text. The student's words are stored in the software application of control 14. Control 14 may prepare performance data based on the recordings of the student's verbal performance on the selected or predetermined academic skill. Control 14 may transmit the performance data to server 16, where the performance data is stored as described in more detail below.

In a similar manner, digital device 12 may display any other sequence of numbers, letters, words, images, or any combination thereof to allow student 24 to practice any other academic skill. Control 14 may provide display instructions and physical instructions for each academic skill. Student 24 may verbally recite a fact associated with the academic skill as the student 24 steps across each sequential digital display 20 as shown in FIG. 2. This movement crosses the student's midline, which has been shown to improve the rate at which student's retain information.

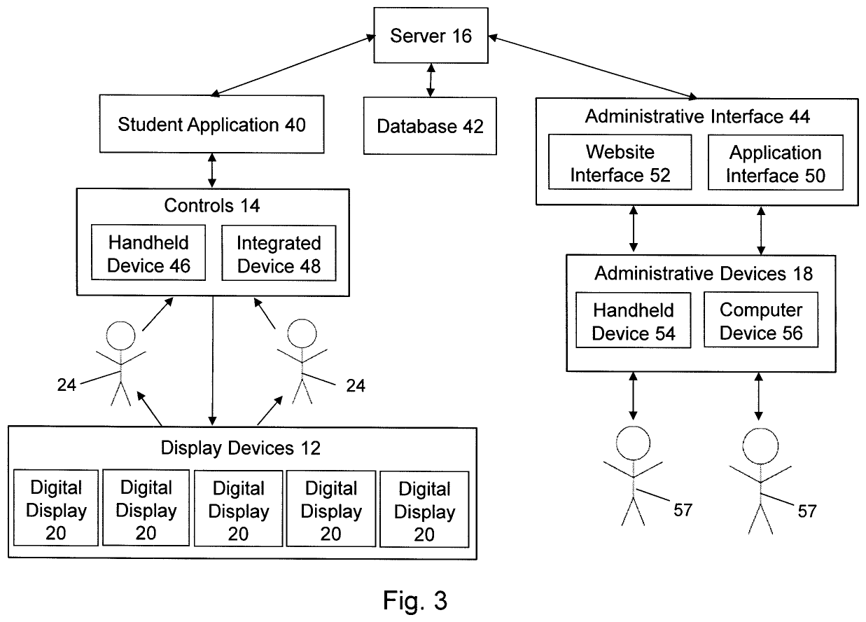

Referring now to FIG. 3, server 16 may electronically communicate with student application 40, database 42, and administrative interface 44. The electronic communications of server 16 with student application 40, database 42, and administrative interface 44 may be accomplished using an internet connection, a local area network connection, or any other connection configured to provide the necessary electronic connection of the listed components. Student application 40 may be housed on one or more controls 14, such as handheld devices 46 or integrated devices 48. Handheld devices 46 may communicate with digital displays 20 through a wireless connection, while integrated devices 48 may be secured to digital devices 12. Server 16 may be in communication with a plurality of controls 14 and display devices 12 through student applications 40. Students 24 may use display devices 12 and controls 14 to practice academic skills. Controls 14 may record data related to the performances of students 24. Controls 14 may then transmit the performance data to server 16 through student application 40.

Administrative interface 44 may be housed on one or more administrative devices 18. Administrative interface 44 may be an application interface 50 or a website interface 52. Administrative devices 18 may be handheld device 54 or computer device 56. Server 16 may be in communication with a plurality of administrative devices 18 through administrative interfaces 44. Administrators 57 may use administrative interface 44 on administrative devices 18 to monitor progress of students 24 with academic skills and to enter student information, student test scores related to academic skills, and to create or modify customized instructions for students' use of display device 12. Administrators 57 may include teachers, parents, school administrators, and any other person involved in the education process. Database 42 may be housed on one or more computers, servers, or any other machine configured to store data and to communicate with server 16.

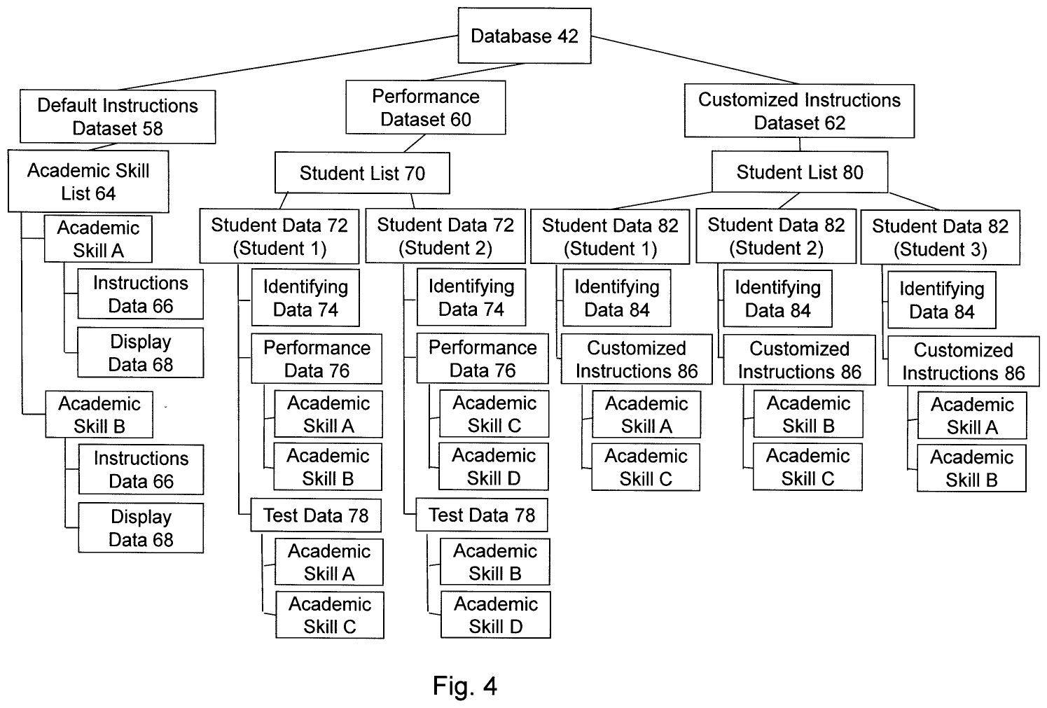

With reference to FIG. 4, database 42 may include default instructions dataset 58, performance dataset 60, and customized instructions dataset 62. Default instructions dataset 58 may include academic skill list 64, which includes the name of a plurality of academic skills that display device 12 may be used to practice. For example, academic skill list 64 in FIG. 4 includes Academic Skill A and Academic Skill B. Default instructions dataset 58 may also include instructions data 66 and display data 68 for each academic skill in academic skill list 64. Instructions data 66 may include the physical instructions provided by control 14 to student 24 for the associated academic skill. Display data 68 may include the display instructions provided to display device 12 with the sequence of numbers, letters, words, images, or any combination thereof to be used with the associated academic skill.

Performance dataset 60 may include student list 70, which includes the name of a plurality of students who have used display device 12 to practice academic skills. The student names on student list 70 may be entered by server 16 in response to data received from controls 14 or in response to data received from administrative devices 18. Performance dataset 60 may include student data 72 for each student on student list 70. For example, student list 70 may include student data 72 for Student 1 and for Student 2. Student data 72 for each student may include identifying data 74, performance data 76, and test data 78 for the student.

Identifying data 74 may include the student's name, school, grade level, age, gender, standardized test scores, or any other identifying information for the student. Identifying data 74 may be entered by server 16 in response to identifying data received from controls 14 or in response to identifying data received from administrative devices 18.

Performance data 76 may include information related to the student's performance in prior sessions of using display device 12 to practice an academic skill as shown above. For example, performance data 76 for Student 1 may include information related to Student 1's performance in using display device 12 to practice Academic Skills A and B. Similarly, performance data 76 for Student 2 may include information related to Student 2's performance in using display device 12 to practice Academic Skills C and D. Performance data 76 may be entered by server 16 in response to data received from controls 14 related to each student's performance with practicing an academic skill using display device 12.

Test data 78 may include information related to the student's performance or score on one or more tests related to academic skills on academic skill list 64 in default instructions dataset 58. For example, test data 78 for Student 1 may include information related to Student 1's performance or score on tests related to Academic Skills A and C. Similarly, test data 78 for Student 2 may include information related to Student 2's performance or score on tests related to Academic Skills B and D. Test data 78 may be entered by server 16 in response to data received from administrative devices 18 related to each student's performance or score on one or more tests related to academic skills in academic skill list 64. In this way, performance dataset 60 includes data related to the performance, scores, or skill level of a plurality of students for a plurality of skills.

Referring still to FIG. 4, customized instructions dataset 62 may include student list 80, which includes the names of a plurality of students who may use display device 12. Student list 80 may include some of the same student names as student list 70 of performance dataset 60. However, student list 80 may include the names of students not included in student list 70. The student names on student list 80 may be entered by server 16 as server 16 creates customized instructions for students' use of display device 12, which may be based on the receipt of performance data 76 from controls 14, the receipt of test data 78 from administrative devices 18, or the receipt of identifying information for a student from controls 14 or administrative devices 18. Additionally, the student names on student list 80 may be entered by server 16 in response to other data received from administrative devices 18. Customized instructions dataset 62 may include student data 82 for each student on student list 80. For example, student list 80 may include student data 82 for Student 1, Student 2, and Student 3. Student data 82 for each student may include identifying data 84 and customized instructions 86.

Identifying data 84 may include the student's name, school, grade level, age, gender, standardized test scores, or any other identifying information for the student. Identifying data 84 may be entered by server 16 in response to identifying data received from controls 14 or in response to identifying data received from administrative devices 18. In one embodiment, when a student name on student list 70 is added to student list 80, server 16 may duplicate identifying data 74 in performance dataset 60 as identifying data 84 in customized instructions dataset 62 for the same student. Similarly, when a student name on student list 80 is added to student list 70, server 16 may duplicate identifying data 84 in customized instructions dataset 62 as identifying data 74 in performance dataset 60 for the same student.

Customized instructions 86 may include information related to the one or more academic skills each student will be directed to practice the next time the student uses display device 12 and control 14. Additionally, customized instructions 86 may include specific instructions that vary from the default instructions for use by the student in practicing a particular academic skill. For example, customized instructions 86 for Student 1 may include instructions for control 14 to direct Student 1 to practice Academic Skills A and C upon the next use of control 14 and display device 12. Student 1's customized instructions 86 may be generated by server 16 in response to performance data 76 and test data 78 in performance dataset 60 for Student 1. Specifically, customized instructions 86 may include Academic Skills A and C if performance data 76 for Academic Skill A and test data for Academic Skills A and C indicated that Student 1 had not mastered Academic Skills A and C. Similarly, customized instructions 86 may not include Academic Skill B if performance data 76 for Academic Skill B indicated that Student 1 had mastered that skill.

In another example, customized instructions 86 for Student 2 may include instructions for control 14 to direct Student 2 to practice Academic Skills B and C upon the next use of control 14 and display device 12. Student 2's customized instructions 86 may be generated by server 16 in response to performance data 76 indicating lack of mastery of Academic Skill C and mastery of Academic Skill D, as well as test data 78 indicating lack of mastery of Academic Skill B and mastery of Academic Skill D.

In yet another example, customized instructions 86 for Student 3 may include instructions for control 14 to direct Student 3 to practice Academic Skills A and B upon the next use of control 14 and display device 12. Student 3's customized instructions 86 may be generated by server 16 in response to a lack of performance data 76 and test data 78 for Student 3. Instead, server 16 may set Student 3's customized instructions 86 based on default instructions in default instructions dataset 58. Alternatively, Student 3's customized instructions 86 may be generated by server 16 in response to instructions received from an administrative device 18, which were entered specifically by an administrator 57 for Student 3.

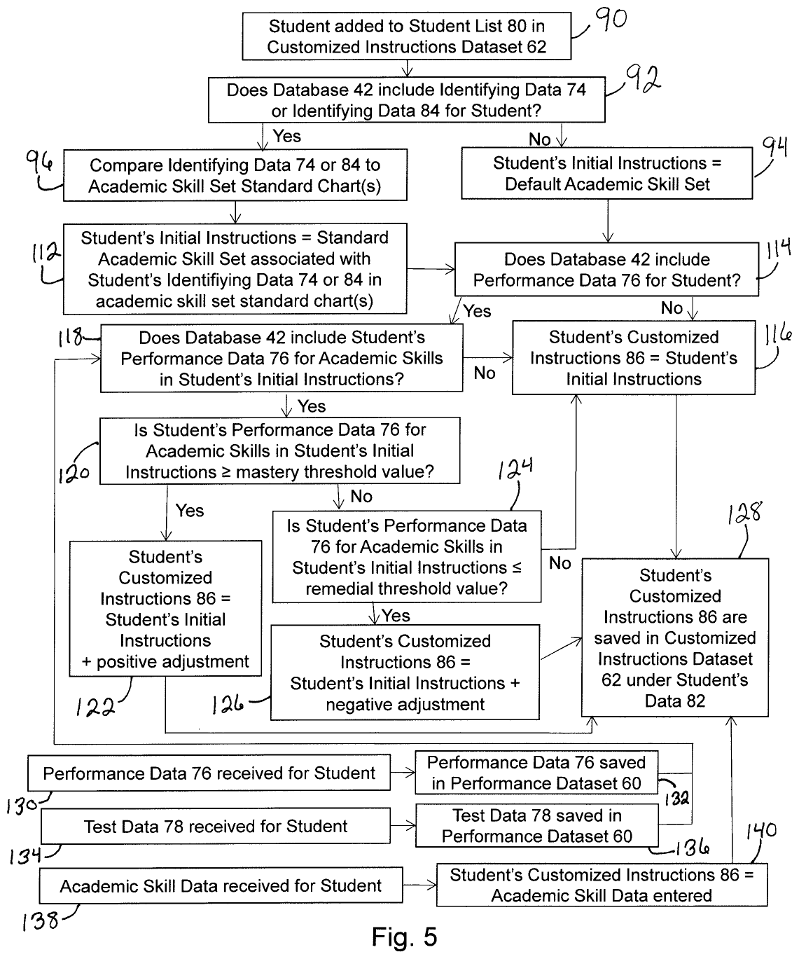

FIG. 5 illustrates the process by which server 16 creates customized instructions 86 for a student. The process of creating customized instructions 86 may be triggered by the addition of a student's name to student list 80 in customized instructions dataset 62 in step 90. The student names may be added to student list 80 by administrators 57 through administrative interface 44 using administrative devices 18. Alternatively, server 16 may add student names to student list 80 in response to the receipt of student data 72 (e.g., performance data 76 or test data 78) in performance dataset 60 for the student. After the student's name is added to student list 80 in customized instructions dataset 62 in step 90, server 16 evaluates whether database 42 includes identifying data 74 or identifying data 84 for the student in step 92. If the result of evaluation step 92 is “No,” then the student's Initial Instructions are set to a Default Academic Skill Set in step 94. The Default Academic Skill Set may be derived from information in the Academic Skill List 64 of the Default Instructions Dataset 58. The Default Academic Skill Set may be designed to provide display data 68 to display device 12 for an academic skill that is commonly practiced by students, which is used when no information about the student is available to server 16. If the result of evaluation step 92 is “Yes,” then server 16 compares identifying data 74 or identifying data 84 for the student to one or more Academic Skill Set Standard Charts in step 96.

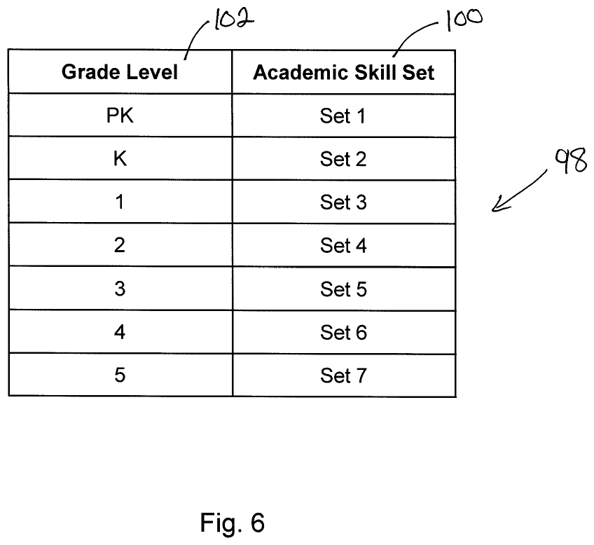

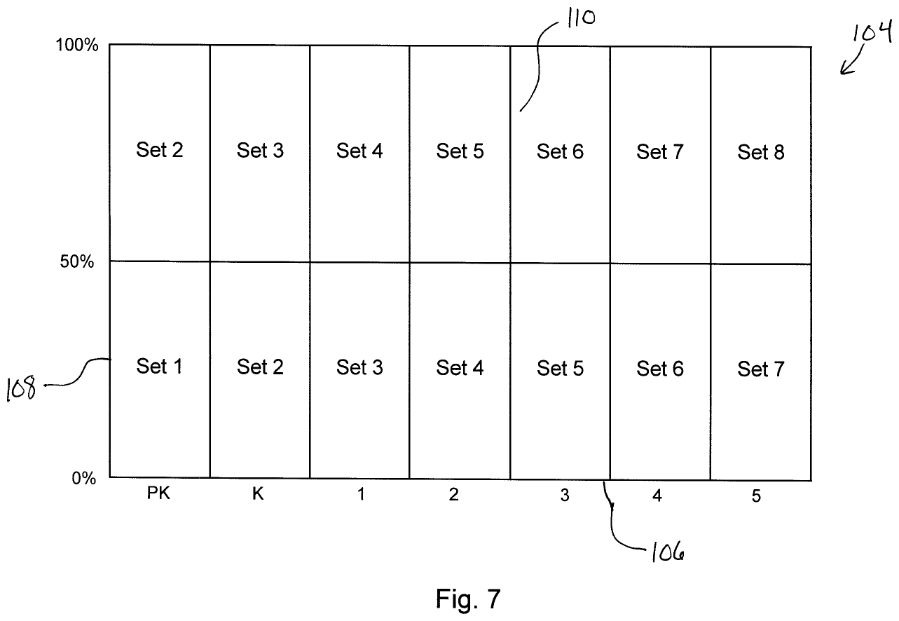

With reference to FIGS. 6 and 7, Academic Skill Set Standard Charts may be stored in database 42. Academic Skill Set Standard Charts may provide an academic skill set recommendation for a student to practice using display device 12 for certain types of identifying information of a student. For example, Academic Skill Set Standard Charts may provide recommendations based on a student's age, grade level, test scores, or any other information related to the student. One embodiment of an Academic Skill Set Standard Chart is illustrated in FIG. 6. Academic Skill Set Standard Chart 98 includes a list of academic skill sets 100 each associated with a grade level 102. Another embodiment of an Academic Skill Set Standard Chart is illustrated in FIG. 7. Academic Skill Set Standard Chart 104 includes a chart in which grade levels 106 are plotted on the x-axis and test scores 108 are plotted on the y-axis. Test scores 108 may be scores on any type of test, including standardized tests. Academic Skill Set Standard Chart 104 includes a designated academic skill set 110 for each combination of grade level 106 and test score 108.

Referring again to FIG. 5, in step 96, server selects an academic skill set that is associated with the student's identifying data 74 or identifying data 84 in the Academic Skill Set Standard Chart(s). In step 112, server 16 sets the student's Initial Instructions to the academic skill set associated with the student's identifying data 74 or identifying data 84 in the Academic Skill Set Standard Chart(s). After the student's Initial Instructions are set in step 94 or in step 112, server 16 evaluates whether database 42 includes performance data 76 for the student in evaluation step 114. If the result of evaluation step 114 is “No,” then the student's Customized Instructions 86 are set to the student's Initial Instructions in step 116. In other words, the student's Initial Instructions are used as the student's Customized Instructions 86 when no performance data 76 is stored in database 42 for the student.

If the result of evaluation step 114 is “Yes,” then server 16 evaluates whether database 42 includes the student's performance data 76 for the academic skills in the student's Initial Instructions in evaluation step 118. If the result of evaluation step 118 is “No,” then the student's Customized Instructions 86 are set to the student's Initial Instructions in step 116. In other words, the student's Initial Instructions are used as the student's Customized Instructions 86 when server 16 includes no indication of the student's performance on the academic skills in the Initial Instructions. If the result of evaluation step 118 is “Yes,” then server 16 evaluates whether the student's performance data 76 for the academic skill(s) in the student's Initial Instructions is equal to or better than a mastery threshold value of the academic skill(s) (i.e., whether the student's performance data 76 indicates mastery of the relevant academic skill(s)) in evaluation step 120. If the result of evaluation step 120 is “Yes” (i.e., the student has mastered the academic skills in the Initial Instructions), then the student's Customized Instructions 86 are set to the student's Initial Instructions with a positive adjustment in step 122. In other words, in step 122, the student's Customized Instructions 86 are set to a more difficult academic skill set than the Initial Instructions if the student's performance data 76 indicates mastery of the academic skill set in the Initial Instructions.

If the result of evaluation step 120 is “No” (i.e., the student has not mastered the academic skills in the Initial Instructions), then server 16 evaluates whether the student's performance data 76 for the academic skill(s) in the student's Initial Instructions is equal to or less than a remedial threshold value of the academic skill(s) (i.e., whether the student's performance data 76 indicates a need for remedial instruction in the relevant academic skill(s)) in evaluation step 124. If the result of evaluation step 124 is “Yes” (i.e., the student need remediation in the academic skills in the Initial Instructions), then the student's Customized Instructions 86 are set to the student's Initial Instructions with a negative adjustment in step 126. In other words, in step 126, the student's Customized Instructions 86 are set to a less difficult academic skill set than the Initial Instructions if the student's performance data 76 indicates a need for remediation in the academic skill set in the Initial Instructions. If the result of evaluation step 124 is “No” (i.e., the student does not need remediation in the academic skills in the Initial Instructions), then the student's Customized Instructions 86 are set to the student's Initial Instructions in step 116. In other words, the student's Initial Instructions are used as the student's Customized Instructions 86 when server 16 includes performance data 76 indicating that the student does not need remediation in, but also has not mastered, the academic skills in the Initial Instructions. Once the student's Customized Instructions 86 are set in step 116, step 122, or step 126 as described above, server 16 saves the student's Customized Instructions 86 in Customized Instructions dataset 62 under the student's student data 82 in step 128.

With reference still to FIG. 5, the evaluations and sequence of steps 114-128 may also be used to set the student's Customized Instructions 86 using the student's test data 78 (rather than the student's performance data 76) in database 42. Alternatively, the evaluations and sequence of steps 114-128 may be used to set the student's Customized Instructions 86 using a combination of the student's performance data 76 and the student's test data 78 in database 42.

Referring again to FIG. 5, when new performance data 76 is received for the student in step 130, server 16 saves the new performance data 76 in performance dataset 60 of database 42 in step 132. In response to the receipt of new performance data 76, server 16 also performs evaluation step 118-128 again for the student using the new performance data 76 to update the student's Customized Instructions 86. Similarly, when new test data 78 is received for the student in step 134, server 16 saves the new test data 78 in performance dataset 60 of database 42 in step 136. In response to the receipt of new test data 78, server 16 also performs evaluation step 118-128 again for the student using the new test data 78 (rather than performance data 76) to update the student's Customized Instructions 86.

With reference still to FIG. 5, server 16 may receive academic skill data for the student from administrators 57 in step 138. The academic skill data may be one or more academic skills that the administrator 57 wishes for the student to practice using display device 12. In response to the receipt of academic skill data in step 138, server 16 sets the student's Customized Instructions 86 based on the academic skill data in step 140. The Customized Instructions 86 set in step 140 are stored in the customized instructions dataset 62 under the student's student data 82 in step 128.

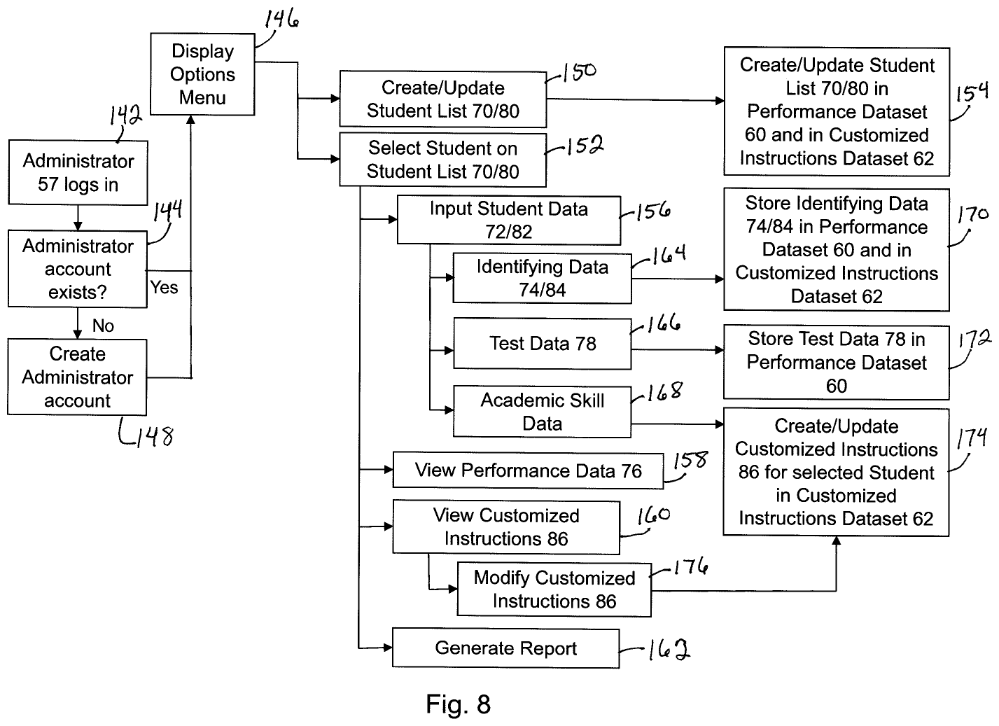

FIG. 8 illustrates the process of administrators 57 using administrative interface 44 with administrative devices 18. The administrator logs in to administrative interface 44 at step 142. Server 16 evaluates whether an administrator account exists for that administrator in evaluation step 144. If the result of evaluation step 144 is “Yes” (i.e., an administrator account exists for that administrator), then an options menu is displayed to the administrator in step 146. If the result of evaluation step 144 is “No” (i.e., an administrator account does not exist for that administrator), then the administrator is prompted to create an account in step 148. Once the administrator creates an account in step 148, the options menu is displayed to the administrator in step 146. The options menu includes option 150 to Create/Update Student Lists 70/80 and option 152 to Select a Student on Student Lists 70/80. If the administrator creates or updates student lists 70/80 associated with the administrator in option 150, then server 16 creates or updates student list 70 in performance dataset 60 and student list 80 in customized instructions dataset 62 in step 154. If the administrator selects a student on student lists 70/80 in option 152, then the administrator is provided option 156 to input student data 72/82 associated with the selected student, option 158 to view performance data 76 associated with the selected student, option 160 to view customized instructions 86 associated with the selected student, and option 162 to generate a report containing data associated with the selected student. If the administrator selects option 156 to input student data 72/82, the administrator may input identifying data 74/84 in step 164, test data 78 in step 166, and/or academic skill data in step 168. If the administrator inputs identifying data 74/84 in step 164, then the server 16 saves identifying data 74/84 in performance dataset 60 and customized instructions dataset 62, respectively, in step 170. If the administrator inputs test data 78, then server 16 saves test data 78 in performance dataset 60 in step 172. If the administrator inputs academic skill data in step 168, the server 16 creates or updates customized instructions 86 for the selected student in customized instructions dataset 62 in step 174. If the administrator selects option 160 to view customized instructions 86 for the selected student, the administrator is provided the option to modify the customized instructions 86 in step 176. If the administrator modifies the customized instructions 86 in step 176, server 16 updates customized instructions 86 for the selected student stored in customized instructions dataset 62 in step 174.

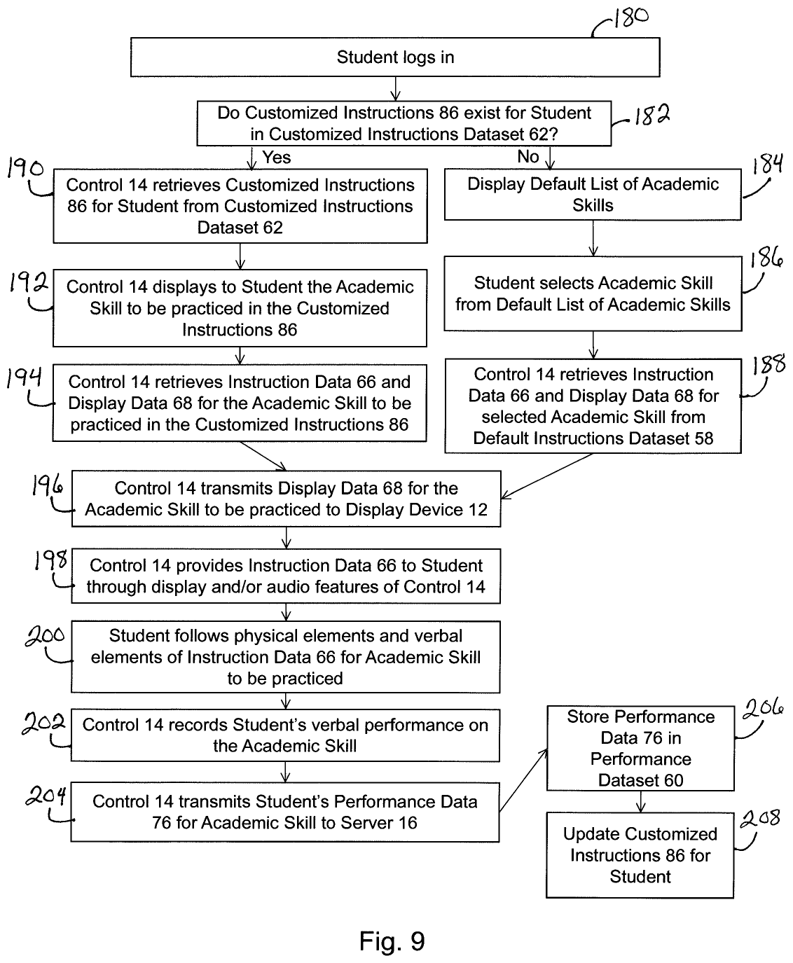

FIG. 9 illustrates the one embodiment of the process by which a student 24 may use controls 14 and display devices 12. The student logs in to student application 40 on control 14 at step 180. Server 16 evaluates whether customized instructions 86 exist for the student in customized instructions dataset 62 in evaluation step 182. If the result of evaluation step 182 is “No” (i.e., no customized instructions 86 exist for the student), then control 14 displays a Default List of Academic Skills to the student in step 184. The student may then select an academic skill from the Default List of Academic Skills using control 14 in step 186. Control 14 may then communicate with server 16 to retrieve instructions data 66 and display data 68 for the selected academic skill from default instructions dataset 58 of database 42 in step 188.

If the result of evaluation step 182 is “Yes” (i.e., customized instructions 86 exist for the student), then control 14 communicates with server 16 to retrieve customized instructions 86 for the student from customized instructions dataset 62 in step 190. Control 14 may then display to the student the academic skill to be practiced in the customized instructions 86 in step 192. Control 14 also retrieves instructions data 66 and display data 68 for the academic skill to be practiced in the customized instructions 86 in step 194. After control 14 retrieves instructions data 66 and display data 68 for the academic skill to be practiced in step 188 or in step 194, control 14 transmits display data 68 for the academic skill to display device 12 in step 196. Control 14 then provides instructions data 66 to the student through a visual display, through an audio feature (e.g., a speaker), or through a combination thereof in step 198. The student follows the physical elements and verbal elements of instructions data 66 for the academic skill in step 200. The physical elements of the instructions data 66 may be instructions to step across digital displays 20 of display device 12 with alternating feet in the pattern shown in FIG. 2. The verbal elements of instructions data 66 may be instructions to verbally recite a fact associated with the academic skill (e.g., “two times two equals four”). Control 14 records the student's performance in following the verbal elements of the instructions data 66 using a microphone or other device for recording sounds in step 202. Control 14 may convert the sound recording of the student's performance with the verbal elements to text using voice recognition software, then calculate a performance measurement of the student on the academic skill by comparing the text to the words the student should have recited for the academic skill. Control 14 then transmits the student's performance data 76 for the academic skill that was practiced to server 16 in step 204. Server 16 may then save the student's performance data 76 in performance dataset 60 in step 206, and server 16 may update customized instructions 86 for the student based on the performance data 76 in step 208.

As used herein, “default instructions dataset” means any set of information that includes display instructions of a series of numbers, letters, words, images, or any combination thereof to be displayed on a series of digital displays of a display device, where the display instructions are designed to allow a student user to practice an academic skill using the display device. As used herein, “performance dataset” means any set of information that includes performance data associated with a student's use of the display device to practice an academic skill. As used herein, “customized instructions dataset” means any set of information that includes customized instructions associated with a single student user of the display device, such as a list of one or more academic skills for the single student to practice using the display device.

In some embodiments, two or more of the default instructions dataset, the performance dataset, and the customized instructions dataset may be merged into a single dataset. For example, the default instructions dataset and the customized instructions dataset may be included in a single dataset that contains both display instructions for the series of digital display of the display device and customized instructions for a single student user. In this example, the database 42 illustrated in FIG. 4 and the processes illustrated in FIGS. 5, 8, and 9 may be rearranged accordingly.

Each device or system described in this disclosure may include any combination of the described components, features, and/or functions of each of the individual device or system embodiments. Each method described in this disclosure may include any combination of the described steps in any order, including the absence of certain described steps and combinations of steps used in separate embodiments. Any range of numeric values disclosed herein includes any subrange therein. Plurality means two or more.

While preferred embodiments have been described, it is to be understood that the embodiments are illustrative only and that the scope of the invention is to be defined solely by the appended claims when accorded a full range of equivalents, many variations and modifications naturally occurring to those skilled in the art from a review hereof.

I claim:

1. A midline educational system comprising:
a display device including a series of digital displays secured to a base, wherein the series of digital displays are spaced apart along a length of the base, wherein the series of digital displays is configured to display a series of numbers, letters, words, images, or a combination thereof for practicing academic skills, and wherein the series of digital displays is configured for midline movement of a student user to practice an academic skill;
a control in electronic communication with the digital displays of the display device, wherein the control is configured to provide display instructions to the digital displays, and wherein the control is configured to record performance data of the student user in practicing the academic skill; and
a server in electronic communication with the control and a database, wherein the database includes a default instructions dataset, a performance dataset, and a customized instructions dataset, wherein the server transmits display instructions contained in the default instructions dataset and customized instructions contained in the customized instructions dataset to the control, and wherein the server receives performance data from the control and stores the performance data in the performance dataset, wherein the server uses the performance data to update the customized instructions contained in the customized instructions dataset.

2. The midline educational system of claim 1, wherein the control is affixed to the display device.

3. The midline educational system of claim 1, wherein the control is in wireless communication with the display device.

4. The midline educational system of claim 3, wherein the control is a smartphone, watch, table, or laptop computer.

5. The midline educational system of claim 1, further comprising a student application housed in the control, wherein the student application communicates with the server and the digital displays of the display device.

6. The midline educational system of claim 5, wherein the control records performance data in the software application based on the student user's use of the display device for practicing the academic skill.

7. The midline educational system of claim 5, further comprising an administrative interface housed in an administrative device, wherein the administrative interface communicates with the server.

8. The midline educational system of claim 7, wherein the administrative interface displays performance data from the performance dataset in the database for one or more students and displays customized instructions from the customized instructions dataset in the database for one or more students to on the administrative device.

9. The midline educational system of claim 8, wherein the administrative interface receives test data for one or more students from an administrative user, and wherein the administrative interface transmits the test data to the server for saving the test data in the performance dataset of the database.

10. The midline educational system of claim 9, wherein the administrative interface receives academic skill data for one or more students from the administrative user, and wherein the administrative interface transmits the academic skill data to the server for updating the customized instructions in the customized instructions dataset of the database.

11. A midline educational method, comprising the steps of:
a) providing a midline educational system comprising: a display device including a series of digital displays secured to a base, wherein the series of digital displays are spaced apart along a length of the base; a control in electronic communication with the digital displays of the display device; and a server in electronic communication with the control and a database;
b) the control receiving from the server display data and instructions data for a selected academic skill, wherein the server retrieves the display data and the instructions data from the database;
c) the control transmitting the display data to the display device, wherein the series of digital displays of the display device displays a series of numbers, letters, words, images, or a combination thereof in response to the display data received from the control;
d) the control providing a student with the instructions data, wherein the instructions data instructs the student to practice the selected academic skill using midline movement across each digital display of the display device while simultaneously verbally reciting facts of the selected academic skill associated with the number, letter, word, image, or combination thereof displayed on each digital display;
e) the control recording the student's performance of verbally reciting the facts of the selected academic skills while using midline line movement with the digital display;
f) the control converting the recording of the student's performance to performance data;
g) the control transmitting the student's performance data to the server.

12. The method of claim 11, wherein the database includes a default instructions dataset, a performance dataset, and a customized instructions dataset, and wherein step (b) further includes the control receiving customized instructions for the student, wherein the customized instructions identifies the selected academic skill, wherein the server retrieves the customized instructions for the selected student from the customized instructions dataset of the database in response to an inquiry for the selected student received from the control, and wherein the server retrieves the instructions data and the display data for the selected academic skill from the default instructions dataset of the database in response to the customized instructions.

13. The method of claim 12, wherein step (g) further comprises the server storing the performance data in the performance dataset of the database in response to receiving the student's performance data from the control.

14. The method of claim 13, wherein the control is configured for voice recognition, and wherein in step (f) the control converts a sound recording of the student's verbal performance to text using voice recognition and comparing the text to a set of facts associated with the selected academic skill to create the performance data.

15. The method of claim 13, wherein in step (a) the midline educational system further includes an administrative interface installed on one or more administrative devices, wherein the administrative interface is in electronic communication with the server; and wherein the method further comprises the step of:
h) in response to an inquiry from one of the administrative devices through the administrative interface for one or more selected students, the server transmitting to the administrative device performance data for the one or more selected students for a user of the administrative device to monitor progress of the one or more selected students in practicing one or more academic skills using the display device.

16. The method of claim 15, further comprising the step of:
i) in response to an inquiry from one of the administrative devices through the administrative interface for one or more selected students, the server generating a performance report for the one or more selected students and transmitting to the performance report to the administrative device through the administrative interface, wherein the performance report includes information related to the progress of the one or more students in practicing one or more academic skills using the display device.

17. The method of claim 15, further comprising the step of:
i) the server receiving test data for one or more selected students from one of the administrative devices through the administrative interface, wherein the server stores the test data in the performance dataset of the database.

18. The method of claim 17, further comprising the step of:
j) the server generating the customized instructions for each student included in a student list of the customized instructions dataset based on performance data and test data in the performance dataset of the database.

19. The method of claim 18, further comprising the step of:
k) in response to an inquiry from one of the administrative devices through the administrative interface for one or more selected students, the server transmitting to the administrative device the customized instructions for the one or more selected students.

20. The method of claim 19, further comprising the step of:
l) the server receiving academic skill data from one of the administrative devices through the administrative interface for one or more selected students, wherein the server adjusts the customized instructions for the one or more selected students in response to the academic skill data received from the administrative device.
